(19) United States
(12) Patent Application Publication
(10) Pub. No.: US 2018/0310047 A1
(43) Pub. Date: Oct. 25, 2018

(54) Method and Apparatus for Synchronizing Audio and Video Signals

(71) Applicant: BOE Technology Group Co., Ltd., Beijing (CN)

(72) Inventor: Ran Duan, Beijing (CN)

(73) Assignee: BOE Technology Group Co., Ltd., Beijing (CN)

(21) Appl. No.: 15/568,758

(22) PCT Filed: Jun. 14, 2017
(86) PCT No.: PCT/CN2017/088268

§ 371 Date: Oct. 23, 2017

(30) Foreign Application Priority Data
Aug. 30, 2016 (CN) 201610772829.2

(51) Int. Cl. H04N 21/43; H04N 21/44; H04N 21/439

(52) U.S. Cl. CPC H04N 21/4302; H04N 21/4392; H04N 21/44

(57) ABSTRACT

A method and apparatus for synchronizing audio and video signals, the method includes: extracting header information of respective image frames contained in the video signal; and adjusting output of the audio signal according to the header information of the respective image frames so as to output the audio data in synchronization with the video signal. In the method and apparatus according to the present disclosures, image frame information of the video signal is extracted, and the corresponding image frame information is provided to the audio signal, so as to adjust output of the audio signal, thus ensuring the synchronization between the output of the audio signal and the output of the video signal, thereby improving quality of audio-visual programs and enhancing user experience.

### TECHNICAL FIELD

The present disclosure relates to the field of multimedia and, more particularly, to a method and apparatus for synchronizing audio and video signals.

### BACKGROUND

With the development of HD (High-Definition) display technology, an image can be displayed in an increasing resolution. To this end, performance of resources, which is required for performing an image processing on a received video signal to finally display an HD image on a display apparatus, is also increased. For example, as for televisions or monitors with the resolution higher than 4K, which have been focused in the display field currently, most of them need to use FPGA or a more powerful dedicated processing chip to process the video signal. However, as illustrated in FIG. 1, since the audio signal and the video signal are processed separately, there is a possibility that output of the processed video signal and output of the processed audio signal are out of synchronization, resulting in a decrease in viewing experience of the user.

### SUMMARY

In view of the above, the present disclosure proposes a method and apparatus for synchronizing audio and video signals. According to the method and apparatus, at the time of processing the video signal, the corresponding information on the image frame is provided to the audio signal, so as to adjust output of the audio signal, thus maintaining output of the audio signal in synchronization with output of the processed video signal, thereby improving quality of audio-visual programs and enhancing user experience.

According to an aspect of the present disclosure, there is provided a method of synchronizing audio and video signals, comprising: extracting header information of respective image frames contained in a video signal; and adjusting output of an audio signal according to the header information of the respective image frames so as to output the audio data in synchronization with the output of the video signal.

According to another aspect of the present disclosure, there is provided an apparatus for synchronizing for synchronizing audio and video signals, comprising: a transceiver that receives an audio signal and a video signal; and a processor configured to extract header information of respective image frames contained in the video signal, and adjust output of the audio signal according to the header information of the respective image frames so as to output the audio data in synchronization with the output of the video signal.

In the method and apparatus according to the present disclosures, image frame information of the video signal is extracted, and the corresponding image frame information is provided to the audio signal, so as to adjust output of the audio signal, thus ensuring the synchronization between the output of the audio signal and the output of the video signal, thereby improving quality of audio-visual programs and enhancing user experience.

### BRIEF DESCRIPTION OF THE DRAWINGS

In order to more clearly illustrate the technical solutions of the embodiments of the present disclosure, hereinafter, the drawings necessary for illustration of the embodiments of the present application will be introduced briefly, the drawings described below are only some embodiments of the present disclosure, and should not be construed as limiting the present disclosure in any way.

FIG. 1 is a schematic block diagram of a known system for processing video and audio signals.

FIG. 2 is a schematic block diagram of a system for processing audio and video signals according to an embodiment of the present disclosure.

FIG. 3 is a schematic diagram of standard timing of I2S (Inter-IC Sound).

FIG. 4 is a schematic timing diagram of right-aligned data bits according to a variant of I2S standard timing.

FIG. 5 is a schematic diagram of a Single-Link DVI interface.

FIG. 6a is a schematic diagram of a system with a Single-Link TMDS channel.

FIG. 6b is a schematic diagram of mapping relationship of respective signals on a Single-Link TMDS channel.

FIG. 7a is a schematic diagram of a TMDS input data stream.

FIG. 7b is a schematic diagram of an encoded TMDS data stream.

FIG. 8 is a schematic flowchart of a method for synchronizing audio and video signals according to an embodiment of the present disclosure.

FIG. 9 is a schematic flowchart for processing audio data according to another embodiment of the present disclosure.

FIG. 10 is a schematic diagram of an apparatus for synchronizing audio and video signals according to another embodiment of the present disclosure.

### DETAILED DESCRIPTION OF THE EMBODIMENTS

Hereinafter, the technical solutions in the embodiments of the present disclosure will be described clearly and comprehensively in combination with the drawings. Obviously, these described embodiments are merely parts of the embodiments of the present disclosure, rather than all of the embodiments thereof. Other embodiments obtained by a person of ordinary skill in the art based on the embodiments of the present disclosure without paying creative effort all fall into the protection scope of the present disclosure.

FIG. 1 is a schematic block diagram of a known system for processing video and audio signals. As illustrated in FIG. 1, digital video data and digital audio data are obtained separately after being decoded by the decoder. As described above, processing of the digital video data and processing of the digital audio data are carried out separately. For example, as for the digital audio data, an analog signal is obtained after a simple digital-to-analog conversion processing and provided to a playback device (e.g., microphone, speaker, etc.) for outputting audio. However, the processing on the digital video data is relatively complex. As illustrated in FIG. 1, the digital video data is supplied to a video processing unit for image processing. For example, processing on the digital video data includes, but not limited to, at least one of color space conversion, color enhancement, frame rate conversion, and pixel format conversion. For this reason, in addition to the video processing unit, a controller and a corresponding memory may be also required. For example, as illustrated in FIG. 1, if a frame rate conversion is to be performed on the respective image frames after the video processing unit performs color enhancement on a video image, interactive processing can be performed via a frame rate conversion module (FRC) (e.g., the controller in FIG. 1) and a DDR (Double Data Rate Synchronous Dynamic Random Access Memory, or DDR SDRAM) chip, thereby realizing the frame rate conversion of the video data. Alternatively, the video processing unit can be used to interact with DDR via a controller, thus performing an image stretching, image enhancing, color adjustment, edge processing, de-noising etc. on an image; after the digital video data has been subjected to various processing, it is outputted to a display terminal for displaying.

It can be seen that, compared to the audio signal, a more complex processing is performed on the video signal; since processing of the video signal and that of the audio signal are carried out separately, no consideration is taken into the synchronization relationship between the video signal and the audio signal, this may result in asynchronization between the video image and the audio signal to be perceived when the outputted audio-visual signal is provided to the user, deteriorating user experience.

To this end, according to an embodiment of the present disclosure, there is provided a solution for synchronizing audio and video signals. More specifically, in the technical solution according to the present disclosure, when the video signal is processed by using the video processing unit, in order to synchronously output the audio signal and the processed video signal to a playback terminal, the audio signal is buffered by using a buffer and information on respective image frames of the video signal is incorporated to the audio signal, so that output of the audio signal and that of the video signal can be in synchronization.

Optionally, according to an embodiment of the present disclosure, the buffered digital audio data can be further provided to the processor that processes the video signal in order to incorporate the associated information on the image frame thereto. Optionally, the processor can be an FPGA (Field-Programmable Gate Array), a DSP (Digital Signal Processor), an ASIC (Application Specific Integrated Circuit), a CPLD (Complex Programmable Logic Device), a dedicated or general purpose processor, and herein no limitation is made.

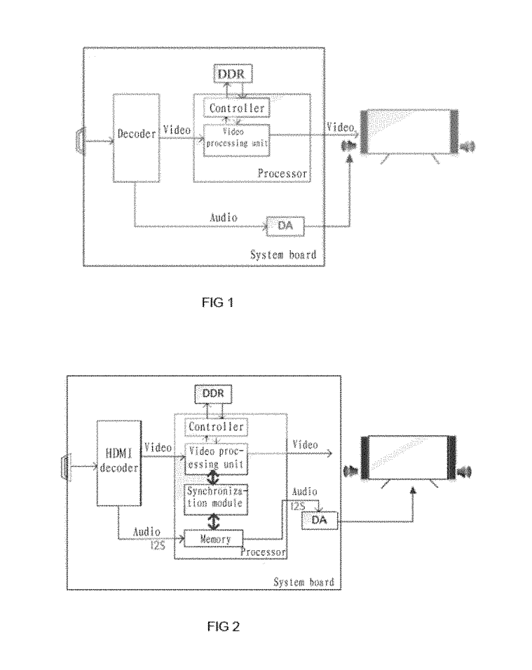

FIG. 2 schematically illustrates a block diagram of a system for processing audio and video signals according to an embodiment of the present disclosure. As illustrated in FIG. 2, a received audio-visual signal is decoded into digital video data and digital audio data via a decoder (e.g., an HDMI decoder). The digital video data is inputted to the video processing unit for processing, for example, performing at least one of color space conversion, color enhancement, frame rate conversion, and pixel format conversion. Meanwhile, the decoded digital audio data is buffered in the memory. By way of example, according to an embodiment of the present disclosure, the digital audio data can be transmitted to the memory for being buffered via an I2S bus.

As illustrated in FIG. 2, a synchronization unit can be added between the memory that buffers the digital audio data and the video processing unit so as to provide header information of image frames in the video data to the audio data. Optionally, header information of respective image frames can be extracted from the digital video data by the video processing unit. Optionally, header information of an image frame can include, but not limited to, at least one of a frame number of the image frame, a transmission protocol of the image frame, and a frame rate of the image frame.

The video data processed by the video processing unit is transmitted to a display terminal via a transmission interface, and the digital audio data to which frame numbers of image frames are added is outputted to an audio playback terminal (which can be an audio playback terminal built in the display terminal, or an external audio playback terminal) via a digital audio bus, so that the audio can be played in synchronization when the image frames are displayed.

According to an embodiment of the present disclosure, the digital audio bus can be an I2S bus. The I2S bus includes three data signal lines: (1) SCK (continuous serial clock), a clock pulse of SCK corresponds to each bit of data of the digital audio, a frequency of SCK=2×sampling frequency×sampling bits; for example, the commonly used sampling frequency can be 48 kHz or 44.1 kHZ, sampling bits, i.e., the data length, can be 16 bits or 24 bits etc.; (2) WS (word select), word (channel) select is used to switch data in the left and right channels, WS being “1” indicates that the left channel data is being transmitted, and WS being “0” indicates that the right channel data is being transmitted; WS can vary at a rising edge or a falling edge of SCK, and a WS signal does not need to be symmetrical; (3) SD (serial data), audio data indicated by binary complement. No matter how many bits of valid data the audio data in the I2S format has, the most significant bit of the data is always transmitted first at the timing of a second SCK pulse immediately after WS changes (which indicates the starting of a frame), so the most significant bit is located at a fixed position, while the least significant bit is dependent on the number of the bits of the data, which allows the number of the bits of a receiving side to be different from that of the bits of a sending side. If the number of the bits which can be processed by the receiving side is less than that of the bits which can be processed by the sending side, the excess data in the lower bits in the data frames can be abandoned; if the number of the bits that can be processed by the receiving side is more than that can be processed by the sending side, the spare bits can be complemented automatically (often being filled up with zero); such synchronization mechanism makes interconnection of a digital audio device more convenient, and will not cause data misplacement.

FIG. 3 is a schematic diagram of standard timing of I2S. As illustrated in FIG. 3, WS indicates a signal in a left or right channel, i.e., it indicates a left channel when it is at a high level, and indicates a right channel when it is at a low level, and SCK is a serial clock for the digital audio data. As illustrated in FIG. 3, when the digital audio data is transmitted with the I2S standard timing, a data bit corresponding to the first clock signal is empty and it starts directly from a data bit corresponding to the second clock signal. If the digital audio data is represented with a bit width of 16 bits, 16 bits of data are transmitted; if 24 bits are used, 24 bits of data are transmitted, and other bit width can be derived likewise.

As described above, since adopting the digital audio data in the I2S format can make the number of bits of the receiving side different from that of the sending side, with this mechanism, according to an embodiment of the present disclosure, frame numbers of image frames of the video signal can be added to data bits other than valid data bits of digital audio data frames, so as to associate the audio data frames with the video image frames, thus synchronizing output of the audio signal and output of the video signal.

With the standard timing of I2S illustrated in FIG. 3 as an example, frame number information of the corresponding image frames is added to data bits other than valid data bit, for example, the frame number information of image frames can be added after the least significant bit, so that the audio data can be associated with image frames of the video signal.

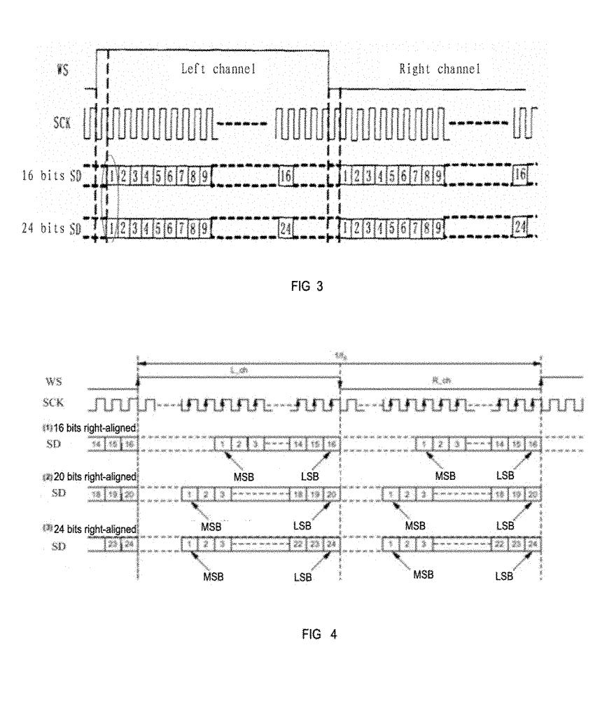

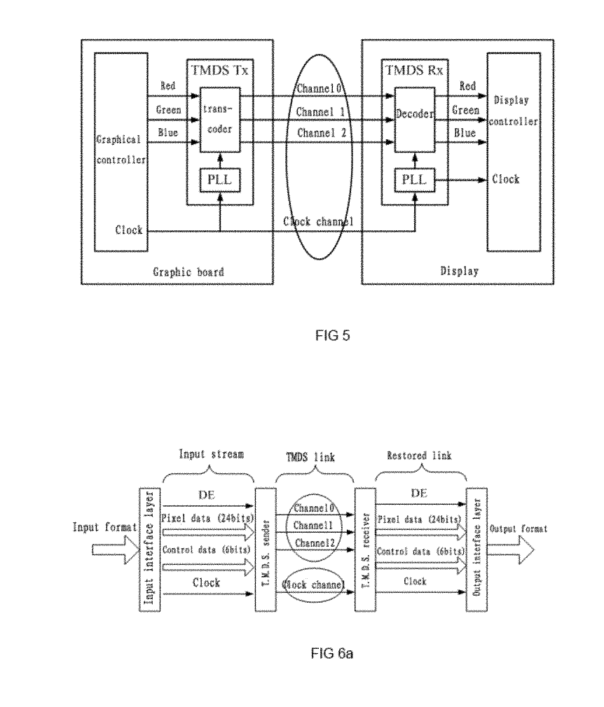

Although a scheme in which the frame number information of image frames is added after the least significant bit of the digital audio data according to an embodiment of the present disclosure is described above with the standard timing of I2S illustrated in FIG. 3 as an example, the principle of the present disclosure is not limited thereto. In fact, under the standard timing of I2S, a left-aligned or right-aligned mode can also be used depending on the different position of the serial data SD relative to WS and SCK. FIG. 4 is a schematic timing diagram of right-aligned data bits according to a variant of I2S standard timing, in this right-aligned mode, the least significant bit of the data corresponds to a SCK pulse immediately before WS changes (which indicates that one frame ends). In this case, frame number information of image frames can be added using spare data bits before the most significant bit, so that the audio data can be associated with image frames of the video signal.

In addition, although the principle of the present disclosure is explained with the audio data being transmitted with I2S bus as an example, it will be understood by a person skilled in the art that, implementation of the principle of the present disclosure is not limited to the use of I2S bus; instead, implementation can be made using any bus capable of transmitting the digital audio data, as long as frame number information of the corresponding image frames is transmitted together with the digital audio data using the digital audio bus; the principle of the present disclosure can be applied to the audio bus such as AES/EBU (Audio Engineering Society/European Broadcast Union) or S/PDIF (Sony/Philips Digital Interface Format).

As described above, after being processed, the digital video signal needs to be transmitted to a display terminal for displaying. It is necessary to transmit image frame information corresponding to a video image to a display terminal, e.g., television set, PC monitor etc., in order to realize synchronization between the video image displayed on the display terminal and the audio signal to be played back. Optionally, header information of an image frame can include at least one of a frame rate of the image frame and a transmission protocol of the image frame, so that the display terminal can learn specific parameters of a received video signal, thereby adjusting the display settings automatically or manually by the user.

According to an embodiment of the present disclosure, it is also possible to include a frame number of an image frame in the header information of the image frame, so that the display terminal can display the video image in synchronization with the audio signal based on frame number information corresponding to the received image frame.

At present, when transmitting the digital video signal, for example, a DVI (Digital Video Interface) interface or an HDMI (High Definition Multimedia Interface) interface can be used. The DVI/HDMI interface can perform digital signal transmission based on the TMDS (Transition Minimized Differential signal) protocol.

The DVI interface is an interface for transmitting the digital signal at a high speed, so that digital-to-analog conversion at the sending side (e.g., graphics card) and analog-to-digital conversion at the receiving side (e.g., LCD display) during transmission of the analog video signal can be removed, and meanwhile, the noise interference problem can be eliminated during transmission of the analog signal, thereby ensuring a quality of the transmitted video signal.

The DVI interface is further divided into Single Link and Dual Link during transmission of the digital signal. As illustrated in FIG. 5, as for the Single-Link DVI interface, there are a total of four channels, channels 0-2 correspond to three components RGB, row and field synchronization signals and some optional control signals are assigned to these three channels, the fourth channel is a clock channel. As described above, DVI performs digital signal transmission based on the TMDS protocol. With 8 bits of R component's transmission as an example, parallel 8 bits of R component need to be converted to serial data during the transmission. For the reliable transmission, a simple parallel-to-serial conversion is not carried out; instead, a TMDS coding algorithm is adopted. The TMDS algorithm enables Transition Minimization of the converted serial signal and DC Balancing of the serial code stream. The serial signal is transmitted in a differential mode. At the receiving side, R, G, B, Hs, Vs, pixel clock and other signals can be decoded through a TMDS receiver.

HDMI derives from DVI interface, and is a transmission technique also based on the TMDS signal; it is a digital video/audio interface technique, and belongs to a dedicated digital interface suitable for image transmission, and can transmit audio and video signals at the same time, without performing digital-to-analog conversion or analog-to-digital conversion before signal transmission. HDMI has additional space that can be utilized in future upgraded audio/video formats.

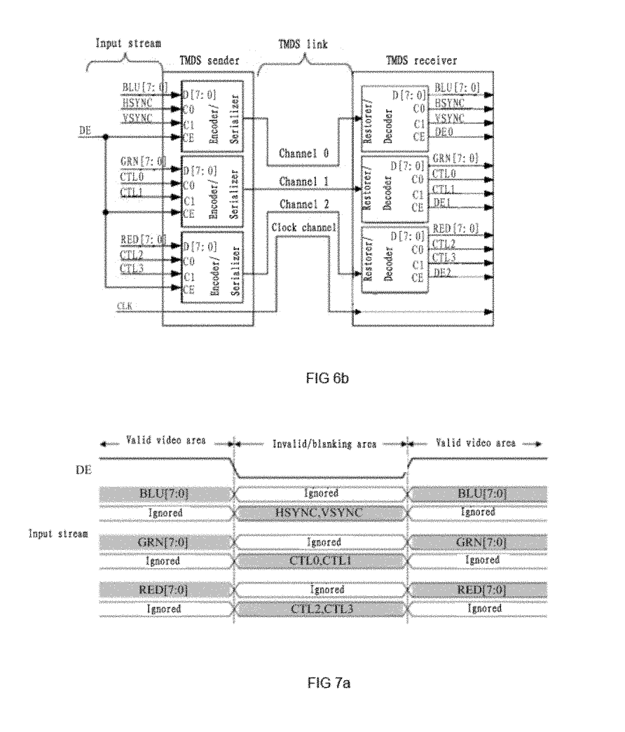

FIG. 6a illustrates a schematic diagram of a system with a Single-Link TMDS channel. As illustrated in FIG. 6a, a TMDS transmission system mainly is divided into two parts: a sending side and a receiving side. On the TMDS sending side, 24 bits of parallel data representing the RGB signals transmitted from, for example the HDMI interface, are received. For example, TMDS encodes each pixel's RGB primary colors with 8 bits, respectively, that is, the RGB signals occupy 8 bits, respectively; thereafter these data is encoded and parallel-to-serial converted, and then the data representing the RGB signals is assigned to separate transmission channels to be transmitted to the receiving side. Correspondingly, on the receiving side, the serial signal from the sending side is received, decoded and serial-to-parallel converted, and then transmitted to the display terminal.

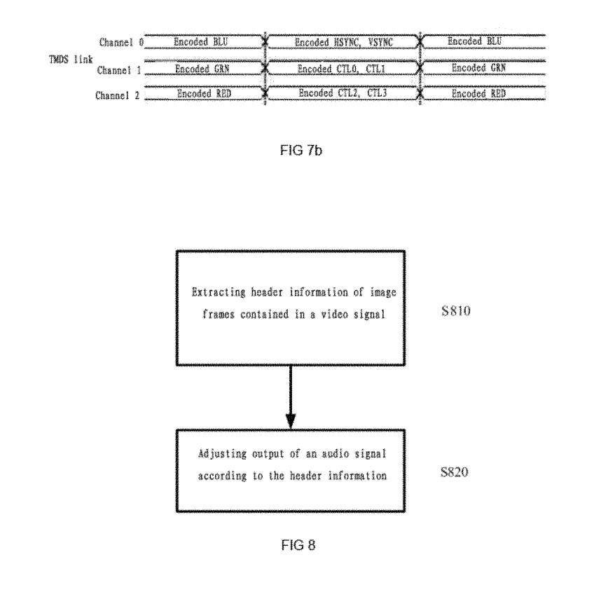

Accordingly, FIG. 6b illustrates a schematic diagram of mapping relationship of respective signals on a Single-Link TMDS channel. Based on the configuration of the TMDS transmission system illustrated in FIGS. 6a-6b, FIG. 7a illustrates a schematic timing diagram of a TMDS input data stream. Herein, the input data stream contains pixel data and control data. A period in which the signal DE is valid indicates the period during which pixel data is transmitted, and a period in which the signal DE is invalid indicates the period in which control data is transmitted. As illustrated in FIG. 7, each TMDS channel includes 2 bits of control data, and there are a total of 6 bits of control data, HSYNC (row sync), VSYNC (field sync), CTL0, CTL1, CTL2, and CTL3, respectively. According to an embodiment of the present disclosure, frame number information of image frames can be embedded into the control bits CTL0, CTL1, CTL2, and CTL3, so as to match with the audio data on the I2S channel.

In other words, according to an embodiment of the present disclosure, when the digital video stream, which has been subjected to video processing, is transmitted to the TMDS sender for encoding, frame number information of image frames can be embedded in the control bits CTL0, CTL1, CTL2, and CTL3 in the digital video stream, so as to match with the audio data on the I2S channel.

Accordingly, as illustrated in FIG. 7b, after receiving the video stream, in which frame number information of image frames is embedded, from the video processing unit, the TMDS sender encodes the video stream, so that in a generated TMDS coding timing, the encoded control bits CTL0, CTL1, CTL2, and CTL3 include frame number information of the respective image frames, so as to match with the audio data to be sent to the audio player, thus synchronously playing the video signal and the audio signal.

FIG. 8 illustrates a schematic flowchart of a method for synchronizing audio and video signals according to an embodiment of the present disclosure. As illustrated in FIG. 8, the method comprises: S810, extracting header information of respective image frames from a video signal; and S820, adjusting output of an audio signal according to the header information of the respective image frames so that the audio signal is output in synchronization with the output of the video signal.

Optionally, the method further comprises: receiving a video signal, to extract header information of image frames.

Optionally, a compressed and encoded video signal is received via an HDMI interface or a DVI interface, and the received signal is decoded, so as to obtain corresponding digital video data.

Optionally, the method further comprises: processing the digital video data, so as to extract header information of respective image frames of the video signal.

Optionally, the header information of an image frame includes at least one of a frame number of the image frame, a frame rate of the image frame, and a transmission protocol of the image frame.

Optionally, processing performed on the digital video data can include, but not limited to, at least one of color space conversion, color enhancement, frame rate conversion, and pixel format conversion.

Optionally, the method further comprises: receiving an audio signal, converting the audio signal into digital audio data.

Optionally, a compressed and encoded audio signal is received via an HDMI interface, and the received signal is decoded so as to be converted to corresponding digital audio data.

Optionally, the method further comprises: buffering the converted digital audio data in a memory via an audio bus.

Optionally, the digital audio data is transmitted to the memory by an Inter-IC Sound (I2S) bus.

Optionally, according to an embodiment of the present disclosure, the method further comprises: adding frame numbers of corresponding image frames to the buffered digital audio data, thus associating the digital audio data with respective image frames of the video signal.

Optionally, in the case where the digital audio data has the I2S format, the method comprises: adding frame numbers of corresponding image frames to a field other than valid sampling data bits of digital audio data.

Optionally, the method comprises: adding frame numbers of corresponding image frames to spare bits before the most significant sample bit or after the least significant sampling bit of the digital audio data.

Optionally, the method further comprises: buffering the digital audio data into the memory in sequence according to reference clock of the I2S bus.

According to an embodiment of the present disclosure, the method further comprises transmitting the processed digital video data to a TMDS interface so as to encode the digital video data via the TMDS interface and transmit the encoded data to a display terminal.

Optionally, the method further comprises: embedding frame numbers of the corresponding image frames in reserved bits corresponding to control data of the digital video data when the processed digital video data is transmitted to the TMDS interface.

Optionally, the method further comprises: encoding the signal in which image frames are embedded when the digital video data is encoded at the TMDS interface, so as to provide frame number information of image frames to the display terminal.

Optionally, the method further comprises: outputting audio in synchronization with the corresponding image frames based on the frame numbers of image frames incorporated to the digital audio data.

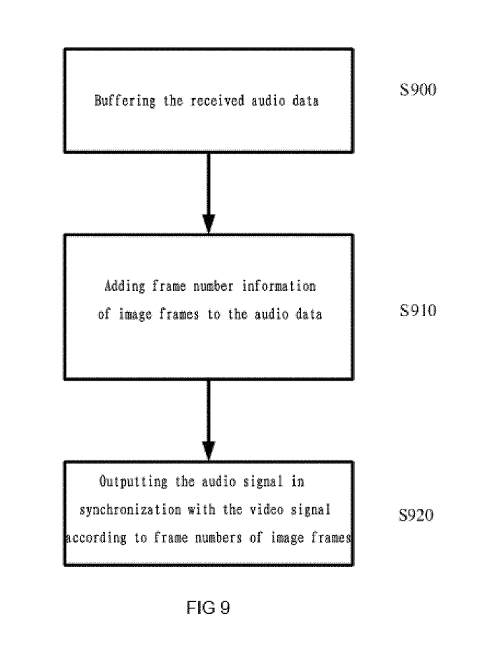

FIG. 9 illustrates a schematic flowchart of processing audio data according to another embodiment of the present disclosure. As illustrated in FIG. 9, S900, buffering the received digital audio data; S910, adding frame number information of corresponding image frames to the buffered digital audio data; and S920, outputting the corresponding digital audio data according to frame numbers of image frames of the video signal to be played.

According to an embodiment of the present disclosure, it is determined whether an audio signal to be outputted matches with image frames of a video signal to be outputted, and in the case of mismatch, the corresponding digital audio data is adjusted according to frame numbers of image frames, and a corresponding audio signal is outputted.

Optionally, based on the frame rates of the extracted image frames, frame numbers of image frames incorporated into the digital audio data are periodically compared with frame numbers of image frames of the video signal to be outputted, so as to determine whether the audio signal, which corresponds to the digital audio data, to be outputted, matches with image frames of the video signal to be outputted.

Considering that frequent adjustment on the audio data can have an effect on sound coherence, optionally, the above-described comparison can be made based on a preset threshold to ensure fluency of the outputted audio. For example, if a difference between the frame numbers of image frames added to the digital audio data and the frame numbers of image frames of the video signal to be outputted exceeds a threshold value, it is determined that the two do not match with other, so that output of the audio data can be adjusted; for example, according to frame numbers of the corresponding image frames, the corresponding audio data can be obtained from the memory that buffers the digital audio data; conversely, if the two match with each other, there is no need to adjust the outputted audio data.

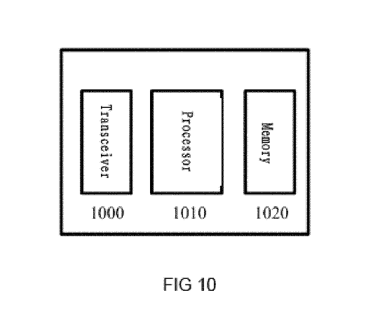

According to another embodiment of the present disclosure, there is provided an apparatus for synchronizing audio and video signals. As illustrated in FIG. 10, the apparatus comprises a transceiver 1000 that receives an audio signal; a processor 1010 configured to extract header information of respective image frames contained in the video signal, and adjust output of the audio signal according to the header information of the respective image frames so as to output the audio signal in synchronization with the output of the video signal.

The transceiver 1000 of the apparatus is further configured to receive a video signal and the processor 1010 is configured to convert the video signal into digital video data and extract header information of respective image frames contained therein.

Optionally, the apparatus further comprises a memory 1020, wherein the processor 1010 converts the received audio signal into digital audio data, and buffers the converted digital audio data in the memory 1020.

Although the memory is illustrated as being built in the above-described apparatus, it will be understood by a person skilled in the art that, the above-described apparatus can include no memory but be connected to an external memory via a bus.

Optionally, the header information of an image frame includes at least one of a frame number of the image frame, a frame rate of the image frame, and a transmission protocol of the image frame.

Optionally, the processor 1010 is configured to add frame numbers of corresponding image frames to the buffered digital audio data, thus associating the digital audio data with respective image frames of the video signal.

Optionally, the apparatus further comprises an I2S bus, and the transceiver 1000 transmits the digital audio data to the memory 1020 via the I2S bus.

Optionally, the processor 1010 is further configured to add adding frame numbers of corresponding image frames to a field other than valid data bits of the buffered digital audio data.

Optionally, the processor 1010 is further configured to sequentially buffer the received digital audio data into the memory 1020 based on reference clock of the I2S bus.

Optionally, the processor 1010 is further configured to convert the received video signal into digital video data and embed frame numbers of respective image frames in reserved bits of the digital video data.

Optionally, the apparatus further comprises a video transmission interface that transmits the digital video data into which the frame numbers of image frames are embedded to a display terminal.

Optionally, the video transmission interface is a TMDS transmission interface, and the processor embeds frame numbers of the corresponding image frames in reserved bits corresponding to control data of the digital video data when the processed digital video data is transmitted to the TMDS interface.

Optionally, the signal in which image frames are embedded is encoded when the digital video data is encoded at the TMDS interface, so as to provide frame number information of image frames to the display terminal.

Optionally, the apparatus further comprises an audio transmission interface, the processor 1010 is configured to control the audio transmission interface to output the audio in synchronization with the video signal by using the frame numbers of image frames added in the digital audio data.

Optionally, the processor is configured to determine whether an audio signal to be outputted matches with image frames of a video signal to be outputted, and in the case of mismatch, the corresponding digital audio data is adjusted according to frame numbers of image frames, and a corresponding audio signal is outputted.

Optionally, the processor is configured to, based on the frame rates of the extracted image frames, periodically compare frame numbers of image frames added to the digital audio data corresponding to the audio signal to be outputted with frame numbers of image frames of the video signal to be outputted, so as to determine whether the audio signal to be output matches with image frames of the video signal to be outputted.

Optionally, the above-described comparison is made based on a preset threshold; if a difference between the frame numbers of image frames added to the digital audio data and the frame numbers of image frames of the video signal to be outputted exceeds a threshold value, it is determined that the two do not match with each other, so that output of the audio data can be adjusted; for example, according to frame numbers of the corresponding image frames, the corresponding audio data can be obtained from the memory that buffers the digital audio data; conversely, if the two match with other, there is no need to adjust the outputted audio data.

Although in the above embodiments, processing of the audio data and processing of the video data are realized by the same processor, the principle of the present disclosure is not limited thereto. In practice, more than one processor can be used to separately process the audio data and the video data. For example, a main processor is used to process the video data, and an auxiliary processor is used to process the audio data; the main processor and the auxiliary processor are connected via a bus, and a memory such as SDRAM or others can be also coupled between them to exchange and synchronize data.

Optionally, the functions of the above-described processors can be implemented by using an FPGA (Field-Programmable Gate Array). As an alternative, the functions of the above-described processors can also be implemented by other hardware, including, but not limited to, DSP (Digital Signal Processor), ASIC (Application Specific Integrated Circuit), CPLD (Complex Programmable Logic Device), as well as dedicated or general-purpose processors, no limitation is made here.

In the method and apparatus according to the present disclosures, image frame information of the video signal is extracted, the corresponding image frame information is provided to the audio signal, so as to adjust output of the audio signal, thus outputting the audio signal in synchronization with the output of the video signal, thereby improving quality of audio-visual programs and enhancing user experience.

The above described merely are specific implementations of the present disclosure, but the protection scope of the present disclosure is not limited thereto, modification and replacements easily conceivable for those skilled in the art within the technical range revealed by the present disclosure all fall into the protection scope of the present disclosure. Therefore, the protection scope of the present disclosure is based on the protection scope of the claims.

The present application claims priority of the Chinese Patent Application No. 201610772829.2 filed on Aug. 30, 2016, the entire disclosure of which is hereby incorporated in full text by reference as part of the present application.

1. An apparatus for synchronizing audio and video signals, comprising:
a transceiver that receives the audio signal and the video signal; and
a processor configured to extract header information of respective image frames contained in the video signal, and adjust output of the audio signal according to the header information of the respective image frames so as to output the audio signal in synchronization with the video signal.

2. The apparatus of claim 1, wherein the processor is further configured to convert the received video signal into digital video data, and extract header information of the respective image frames contained therein.

3. The apparatus of claim 2, wherein the header information of an image frame includes at least one of a frame number of the image frame, a frame rate of the image frame, and a transmission protocol of the image frame.

4. The apparatus of claim 3, further comprising a memory, wherein the processor is configured to convert the audio signal into digital audio data, and the converted digital audio data is buffered in the memory.

5. The apparatus of claim 4, wherein the processor is configured to add frame numbers of corresponding image frames to the buffered digital audio data, so that the digital audio data is associated with respective image frames of the video signal.

6. The apparatus of claim 5, wherein the processor is configured to transmit the converted digital audio data to the memory for buffering via a digital audio bus, and the processor is further configured to add frame numbers of corresponding image frames to a field other than valid audio data bits of the digital audio data.

7. The apparatus of claim 5, wherein the processor is configured to determine whether the audio signal to be outputted matches with image frames of the video signal to be outputted, and in a case of mismatching, adjust corresponding digital audio data according to the frame numbers of image frames and output a corresponding audio signal.

8. The apparatus of claim 7, wherein the processor is configured to periodically compare frame numbers of image frames added to the digital audio data corresponding to the audio signal to be outputted with frame numbers of image frames of the video signal to be outputted, so as to determine whether the audio signal to be outputted matches with image frames of the video signal to be outputted.

9. The apparatus of claim 3, wherein the processor is configured to perform image processing on the converted digital video data and embed frame numbers of respective image frames in reserved bits of control data of the processed digital video data.

10. The apparatus of claim 9, wherein the transceiver is configured to transmit the processed digital video data in which frame numbers of image frames are embedded to a display terminal via a transmission interface.

11. A method for synchronizing audio and video signals, comprising:
extracting header information of respective image frames contained in the video signal; and
adjusting output of the audio signal according to the header information of the respective image frames so as to output the audio signal in synchronization with the video signal.

12. The method of claim 11, wherein the header information of an image frame includes at least one of a frame number of the image frame, a frame rate of the image frame, and a transmission protocol of the image frame.

13. The method of claim 12, further comprising: receiving the audio signal, converting the audio signal into digital audio data, and buffering the converted digital audio data in a memory.

14. The method of claim 13, further comprising: adding frame numbers of corresponding image frames to the buffered digital audio data, so that the digital audio data is associated with respective image frames of the video signal.

15. The method of claim 14, wherein the converted digital audio data is transmitted via a digital audio bus to the memory for buffering, and frame numbers of corresponding image frames are added to a field other than valid audio data bits of the digital audio data.

16. The method of claim 14, wherein it is determined whether the audio signal to be outputted matches with image frames of the video signal to be outputted, and in a case of mismatching, the corresponding digital audio data is adjusted according to frame numbers of image frames and a corresponding audio signal is outputted.

17. The method of claim 16, wherein frame numbers of image frames to be added to the digital audio data corresponding to the audio signal to be outputted are periodically compared with frame numbers of image frames of the video signal to be outputted, so as to determine whether the audio signal to be outputted matches with image frames of the video signal to be outputted.

18. The method of claim 12, further comprising: receiving the video signal, converting the video signal into digital video data, and extracting header information of the respective image frames contained therein.

19. The method of claim 18, wherein the converted digital video data is subjected to image processing and frame numbers of respective image frames are embedded in reserved bits of control data of the processed digital video data.

20. The method of claim 19, wherein the processed digital video data in which frame numbers of image frames are embedded is transmitted to a display terminal via a transmission interface.
